(19) United States
(12) Patent Application Publication
(10) Pub. No.: US 2018/0105435 A1
(43) Pub. Date: Apr. 19, 2018

(54) Recovery of Metal Chlorides from Filter Dust

(71) Applicant: Kronos International, Inc., Leverkuesen (DE)

(72) Inventors: Mitja Medved, Leverkusen (DE); Thomas Pierau, Leverkusen (DE)

(73) Assignee: Kronos International, Inc., Leverkuesen (DE)

(21) Appl. No.: 15/295,326

(22) Filed: Oct. 17, 2016

(30) Foreign Application Priority Data
Oct. 16, 2016 (EP) 15002949.4

(51) Int. Cl. C01G 49/10; C01G 33/00; C01G 23/02; B01D 7/00; B01D 7/02

(52) U.S. Cl. CPC C01G 49/10; C01G 33/00; B01D 7/02; B01D 7/00; C01G 23/024

(57) ABSTRACT

The invention relates to a method for separating valuable metal chlorides, particularly titanium tetrachloride and niobium pentachloride, from solid residues, in particular the filter dust generated during the chlorination of raw materials containing iron and titanium in the production of titanium dioxide using the chloride process.

### RELATED APPLICATIONS

This application claims the benefit of Patent App. No. EP 15002949.4 filed Oct. 16, 2016.

### BACKGROUND

### Field of the Invention

The invention relates to a method for separating metal chlorides from filter dust and more particularly separating valuable metal chlorides such as titanium tetrachloride and niobium pentachloride from solid residues generated during the chlorination of raw materials containing iron and titanium in the framework of the chloride process to produce titanium dioxide.

### Technological Background of the Invention

In titanium dioxide (TiO₂) production by the chloride process, raw materials containing iron and titanium are reacted in a chlorinator, primarily into titanium tetrachloride (TiCl₄) and ferrous chloride (FeCl₂). Together with other metal chlorides, some of which are valuable, and water-insoluble solids, FeCl₂ is separated from the TiCl₄-containing gas leaving the chlorinator in a downstream cyclone separator in the form of “cyclone dust”.

The separated fine particles (cyclone dust) are usually removed from the system, along with the adhering valuable substances. Furthermore, owing to the nature of the cyclone dust, a substantial portion of the TiCl₄-containing gas also passes into the dust product stream and the downstream apparatus, along with the dust. These titanium tetrachloride quantities are thus lost to the actual production process.

The cyclone dust consists of coke, unreacted raw material containing iron and titanium, and metal chlorides, and is customarily made into a suspension with dilute hydrochloric acid, in which the metal chlorides react into the corresponding salts by hydrolysis. Depending on the composition of the raw materials, the suspension can generally be used, following separation of the solids, to produce a saleable iron chloride solution with an iron chloride content of roughly 20 wt. % that contains a number of other metal chlorides, some of which are valuable. One particularly valuable metal chloride in this context is niobium pentachloride (NbCl₅). The solids (coke and unreacted raw material) separated from the suspension are put to further use. The material is usually utilised thermally or used in its entirety.

Against the backdrop of the current, global raw material situation, and the general need to conserve raw-material resources, there is an interest in recovering the metal chlorides present in the solid residues (cyclone dust) from TiO₂ production by the chloride process, particularly TiCl₄ and NbCl₅.

Previous work on the recovery of niobium (Nb) and other valuable substances, such as vanadium (V), from the co-product streams of the chloride process related, on the one hand, to extraction of the valuable substances from the suspension formed, or from the iron chloride solution, by using complexing agents and solvents, for example, and, on the other hand, to precipitation of the valuable substances by using special precipitation chemicals, such as phosphate compounds (see DE 10 2011 106864 B4, DE 10 2011 106750 A1, for example).

### BRIEF DESCRIPTION OF THE INVENTION

The object of the invention is to provide a method, with the help of which valuable metals can be selectively recovered from the solid residues, preferably cyclone dust generated during TiO₂ production using the chloride process.

The object is solved by a method for recovering valuable metal chlorides from dry, metal chloride-containing dust, preferably generated during the carbochlorination of raw materials containing iron and titanium, comprising the following steps:

(i) Heating said dust in order to evaporate or sublimate said valuable metal chlorides, so as to obtain a gas stream containing the valuable metal chlorides, and a metal chloride-depleted dust fraction, and
(ii) Resublimation of said valuable metal chlorides contained in said gas stream.

Further advantageous embodiments of the method are contained in the sub-claims.

### BRIEF DESCRIPTION OF THE FIGURES

For a more complete understanding of the present invention and for further advantages thereof, reference is now made to the following description taken in conjunction with the accompanying drawings in which:

FIG. 1: Schematic illustration of a first preferred embodiment of the method according to the invention.

FIG. 2: Schematic illustration of a second preferred embodiment of the method according to the invention.

### DESCRIPTION OF THE PREFERRED EMBODIMENTS

The present invention can be better understood by the following discussion of the structure and use of certain preferred embodiments. All data disclosed below regarding temperature, pH value, concentration, etc. are to be interpreted as also encompassing all values lying within the range of the respective measuring accuracy known to the person skilled in the art. The term “substantially free” is intended to connote that the particular material is not detected (i.e. is below the detection limit) using standard commercial tests and methodologies used in the industry as of the earliest priority date of this application and to allow for the presence of minor trace amounts that may be present as impurities or contaminants in commercially available materials. The term “about” with respect to numerical values and/or ranges is intended to capture the full range of measuring accuracy and uncertainty ranges of standard commercial tests.

The method according to the invention is based on the solid residues containing metal chlorides that are generated during carbochlorination in the framework of the chloride process for titanium dioxide production. These residues are the dry solids separated from the gas stream directly downstream of the chlorinator by means of a cyclone separator in the form of “cyclone dust”.

In carbochlorination, the raw material containing iron and titanium is reacted into gaseous metal chlorides in a fluidized bed in the presence of petroleum coke and chlorine. The principal products are TiCl₄, FeCl₂, AlCl₃, MnCl₂, MgCl₂, VOCl₃, VOCl₂, SiCl₄, ZrCl₄, NbCl₅, CrCl₃ and WCl₆. However, part of the raw materials does not react completely and is discharged from the chlorinator as the fine fraction (cyclone dust), together with the gaseous chlorides. Directly after leaving the chlorinator, the gas stream is cooled and passed through a cyclone dust separator at a temperature of roughly 165° C., in which context a major portion of the fine particles is separated off. Owing to the temperature conditions prevailing in the cyclone separator, as well as the porosity and high specific surface area of the fine particles, metal chlorides adhere to the fine particles, particularly including TiCl₄, NbCl₅, FeCl₂, VOCl₂ and VOCl₃. Part of the metal chlorides is present in condensed form, the adhesion mechanisms particularly being based on temperature-dependent capillary condensation and surface condensation.

The method according to the invention makes it possible to recover valuable metal chlorides, particularly TiCl₄ and NbCl₅, directly from the dust stream downstream of the cyclone separator. At this point in the process, the concentration of valuable substances is relatively high, and the material anhydrous. The method according to the invention is based on the principle of evaporation or sublimation and resublimation of the metal chlorides. The cyclone dust is heated, and the adhering, valuable metal chlorides evaporated or sublimated, in step (i). In this context, the temperature can be set in such a way that largely selective evaporation of the valuable metal chlorides occurs. The evaporated/sublimated metal chlorides are subsequently transported to a cooling device by means of a dry, chemically inert carrier gas, and deposited on cooled surfaces by resublimation in Step 2. Deposition can preferably likewise be performed selectively, then being governed by, for example, the boiling points of the pure substances at standard pressure, e.g. VOCl₃—126° C., TiCl₄—136° C., NbCl₅—248° C., VOCl₂—380° C., FeCl₂—1,025° C., or by their vapour pressure curves.

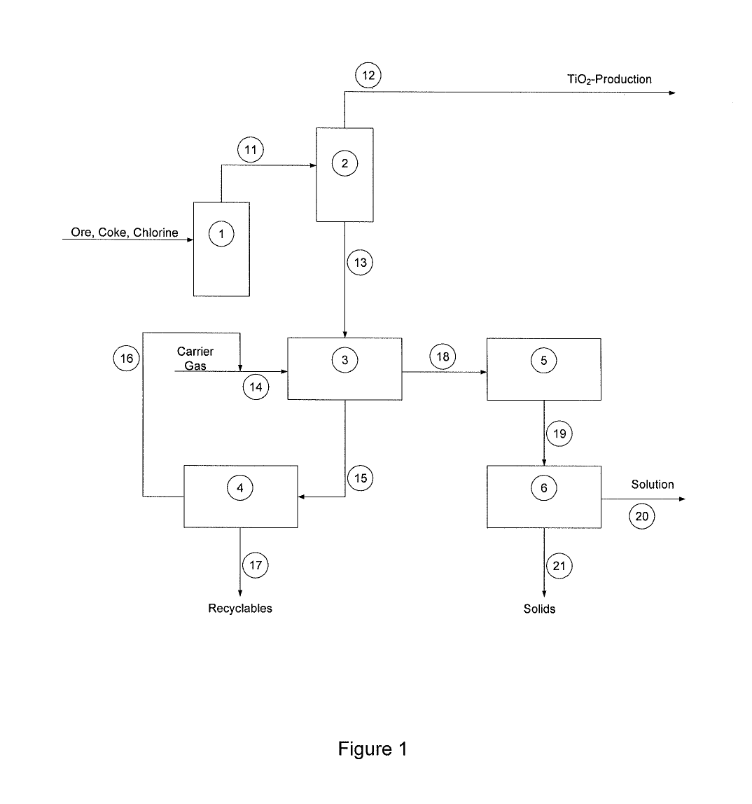

FIG. 1 shows a schematic illustration of one embodiment of the method according to the invention. The gas stream (11) generated during the reaction of raw material containing iron and titanium with chlorine gas and coke in the chlorinator (1) is passed through the cyclone dust separator (2) in the known manner. The separated TiCl₄-containing gas stream (12) is fed to the further process steps for titanium dioxide production. In Step (i) of the method according to the invention, the solids (13, cyclone dust) separated off in the cyclone separator (2), which also contain the adhering, valuable metal chlorides, are fed to a heatable mixing device (3), in which the metal chlorides are selectively evaporated or sublimated, a carrier gas (14) being added. In Step (ii) of the method according to the invention, the metal chloride-containing carrier gas stream (15) is fed to a cooling device (4), where controlled resublimation takes place. The solid metal chlorides formed are separated off and put to further use (17). The carrier gas (16) remaining after the resublimation step is preferably returned to the heatable mixing device (3).

The solids (18) remaining after evaporation/sublimation of the metal chlorides are, as in the known methods, made into a suspension with aqueous hydrochloric acid and simultaneously hydrolysed (5). The hydrolysed suspension (19) is subsequently subjected to solid-liquid separation (6), during which a saleable, iron chloride-containing solution (20) and an inert solid (21) are obtained.

According to the invention, the apparatus known to the skilled person is suitable as the heatable mixing device (3) (hereinafter: mixing device), particularly heatable ploughshare mixers or twin-screw mixers. A carrier gas (14) ideally flows through the mixing device, preferably dried N2 or a TiCl4-containing gas stream, in order to entrain the evaporating/sublimating metal chlorides from the dust matrix and pass them out of the mixing device. The temperature and/or partial pressure conditions set in the mixing device must be selected in such a way that the metal chlorides to be separated off are always present in the vapour phase.

In various embodiments, it is also possible to use multiple mixing devices, which can be connected both in series and in parallel, and in which increasingly high temperatures are set in order to be able to evaporate/sublimate the metal chlorides separately or in fractions.

The gas stream (15) generated during evaporation/sublimation is fed into a cooling device (4), which is preferably a cooling screw, a thin-film crystalliser or a resublimation chamber. The cooling device is operated with a cooling medium, e.g. with heating steam or thermal oils. The person skilled in the art is familiar with substances of this kind. The gas stream (15) is cooled and the metal chlorides are separated from the gas stream as solids in accordance with their substance-specific, different condensation and sublimation points under the respectively prevailing, local pressure conditions. The solids preferably consist of the pure, preferably anhydrous metal chlorides and are discharged from the cooling device (17). They can either be put directly to further use or, alternatively, converted into the oxide form with lower energetic value by aqueous hydrolysis in a subsequent step. The oxide form can subsequently be put to further use as a solution, a suspension or, following a suitable drying step, as a solid.

The carrier gas stream (16) leaving the cooling device (4) is preferably fed back into the mixing device (3).

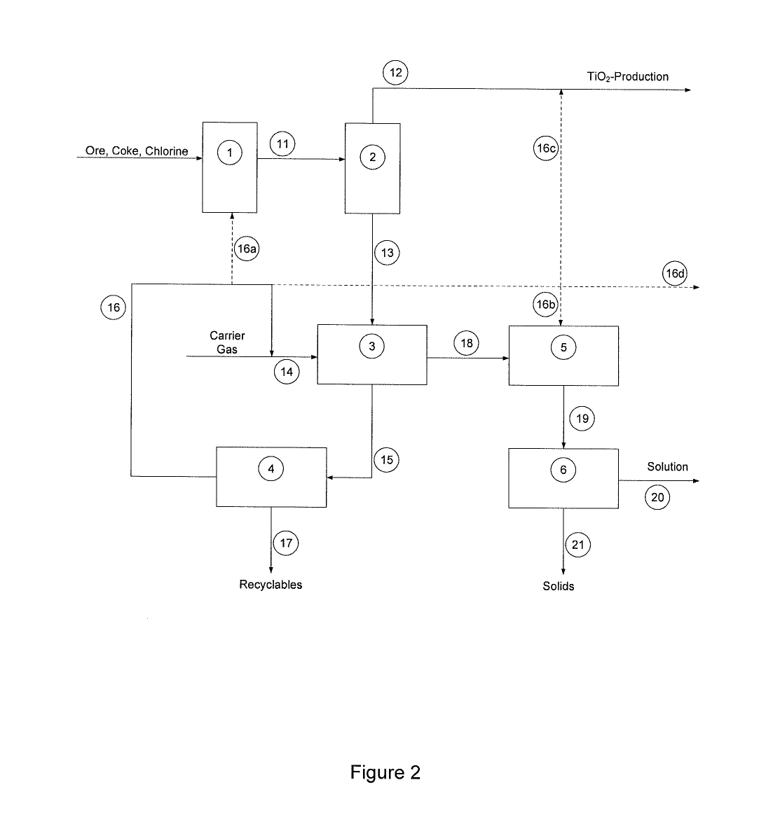

Beyond this, there are further options for utilising the carrier gas (16). They are illustrated schematically in FIG. 2.

If the carrier gas contains TiCl₄, the temperature in the cooling device (4) is preferably set to a temperature above the condensation temperature of TiCl₄, such that the TiCl₄ is kept in gaseous form as completely as possible in the carrier gas stream (16). Alternatively, the TiCl₄-containing carrier gas (16) can be passed with stream (16a) into the chlorinator (1) or with stream (16b) into the pasting unit (5), which contains the solids (18) remaining after evaporation/sublimation of the metal chlorides. In a further embodiment, the TiCl₄-containing carrier gas stream can also be fed as stream (16c) into the gas stream (12) emerging from the dust separator cyclone (2). Finally, the carrier gas stream (16) can also be sent directly for disposal via stream (16d).

With the help of the method according to the invention, valuable metal chlorides, such as NbCl₅, can easily be separated from the cyclone dust and recovered as solid material in the resublimation apparatus (cooling device). By controlling the temperature in the resublimation apparatus (cooling device), the TiCl₄ present in the cyclone dust can, for example, be returned to the chlorinator in gaseous form as stream (16a).

In contrast to known methods addressing the recovery of valuable substances from cyclone dust, implementation of the method according to the invention requires no further chemicals or auxiliaries. Moreover, only apparatus of straightforward design, and with simple control in the form of temperature and pressure control, is necessary.

### EXAMPLES

An example of the invention is described below, although this is not to be taken as a limitation of the invention.

The cyclone dust customarily consists of roughly 30 wt. % coke, 30 wt. % unreacted ore and 40 wt. % metal chlorides. The metal chloride fraction primarily consists of FeCl₂ and other high-boiling chlorides that were not separated off in the cyclone separator. The concentrations of NbCl₅ and TiCl₄ adsorbed on the cyclone dust are customarily each in the region of 1 wt. %. They are, however, subject to the natural fluctuations in the iron/titanium raw materials.

In order to recover NbCl₅ from commercially generated cyclone dust, following the carbochlorination of iron and titanium containing raw materials, the cyclone dust was passed continuously into a mixing device (3) at a feed rate of 3.7 kg/h. The mixing device was set to a temperature of 300° C. and an operating vacuum of 500 mbar by means of a pump, such that the NbCl₅ sublimated and the TiCl₄ evaporated. The quantity of carrier gas (N₂) introduced into the mixing device (3) was set to 0.2 kg/h.

The gas stream laden with NbCl₅ and TiCl₄ was passed into a cooling screw (4) and cooled down to a temperature of 80° C. at an ambient pressure of approx. 1 bar, in which context NbCl₅ was predominantly obtained as a solid, TiCl₄ predominantly remaining in the gas stream. The NbCl₅ recovery rate was more than 65%, referred to the quantity entrained by the cyclone dust, the TiCl₄ recovery rate being more than 80%, again referred to the total quantity entrained by the cyclone dust. The TiCl₄-containing carrier gas stream was partly returned to the chlorinator (1) and partly to the mixing device (3).

In an alternative embodiment using the same quantity of carrier gas and the same feed rate, the cyclone dust was heated to 330° C. at 400 mbar in the mixing device, and the resultant gas phase likewise cooled to 80° C. in the cooling screw (4). In this case, an NbCl₅ recovery rate of more than 80% was achieved, referred to the total quantity entrained by the cyclone dust. The TiCl₄, recovery rate was maintained at more than 80%, again referred to the total quantity entrained by the cyclone dust.

In a further embodiment using a carrier gas quantity of 0.05 kg/h and the same feed rate, the cyclone dust was heated to 330° C. at 100 mbar in the mixing device, and the resultant gas phase cooled to 125° C. in the cooling screw (4). In this case, too, both NbCl₅ and TiCl₄ recovery rates of more than 80% were achieved, both referred to the total quantity entrained by the cyclone dust.

The above descriptions of certain embodiments are made for the purpose of illustration only and are not intended to be limiting in any manner. Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

What is being claimed is:

1. A method for separating one or more valuable metal chlorides from dry, metal chloride-containing dust comprising the steps of:
(i) heating the dust to a temperature and at a pressure sufficient to evaporate or sublimate the one or more valuable metal chlorides;
(ii) separating a gas stream containing the one or more valuable metal chlorides from a metal chloride-depleted dust fraction, and
(iii) resublimating the valuable metal chlorides from the gas stream.

2. The method of claim 1 wherein the dry metal chloride-containing dust is generated during the carbochlorination of raw materials containing iron and titanium.

3. The method of claim 1 wherein the valuable metal chlorides are selected from the group consisting of TiCl₄, NbCl₅, and mixtures thereof.

4. The method of claim 1 wherein the valuable metal chlorides are selectively evaporated or sublimated in step (i).

5. The method of claim 1, wherein step (i) is carried out in a heatable mixing apparatus.

6. The method according to claim 5, wherein the heatable mixing apparatus is selected from the group consisting of a heatable ploughshare mixer or a twin-screw mixer or combinations thereof.

7. The method of claim 1 wherein the valuable metal chlorides are selectively resublimated in step (iii).

8. The method of claim 1 wherein step (iii) is carried out in a cooling device.

9. The method of claim 8 wherein the cooling device is selected from the group consisting of a cooling screw, a thin-film crystallizer, a resublimation chamber, or combinations thereof.

10. The method of claim 1, wherein a carrier gas is added prior to or during step (i) and the gas stream in steps (ii) and (iii) is the carrier gas containing the one or more valuable metal chlorides.

11. The method of claim 10, wherein the carrier gas comprises dried N₂ or TiCl₄.

12. The method of claim 10, further comprising the step of returning the carrier gas to step (i) after the completion of step (iii).

13. The method of claim 10, wherein the dry metal chloride-containing dust is generated during a carbochlorination of raw materials containing iron and titanium and the TiCl₄-containing carrier gas is returned to the carbochlorination process after step (iii).

14. The method of claim 1, further comprising the step of hydrolyzing the metal chloride-depleted dust fraction from step (ii) in an aqueous suspension and separating it into an iron chloride-containing solution and a solid.

15. The method of claim 1, wherein:
the dry metal chloride-containing dust is generated during the carbochlorination of raw materials containing iron and titanium;
at least one of the one or more valuable metal chlorides is selected from the group consisting of TiCl₄, NbCl₅, and mixtures thereof;
a carrier gas is added prior to or during step (i) and the gas stream in steps (ii) and (iii) is the carrier gas containing the one or more valuable metal chlorides;

16. The method of claim 1 wherein the valuable metal chlorides are selected from the group consisting of TiCl₄, NbCl₅, and mixtures thereof.

17. The method of claim 15 wherein:
step (i) is carried out in a heatable mixing apparatus selected from the group consisting of a heatable ploughshare mixer or a twin-screw mixer or combinations thereof; and
step (iii) is carried out in a cooling device; selected from the group consisting of a cooling screw, a thin-film crystallizer, a resublimation chamber, or combinations thereof.

18. The method of claim 17, wherein:
the valuable metal chlorides are selected from the group consisting of TiCl₄, NbCl₅, and mixtures thereof;
the carrier gas comprises dried N₂ or TiCl₄; and
following step (iii) the carrier gas is returned to step (i) or to the carbochlorination process.

19. The method of claim 18 wherein the valuable metal chlorides are selectively resublimated in step (iii).

20. The method of claim 15 wherein the valuable metal chlorides are selectively resublimated in step (iii).

21. The method of claim 15, wherein the carrier gas comprises dried N₂ or TiCl₄.

22. The method of claim 15, further comprising the step of returning the carrier gas to step (i) after the completion of step (iii).

23. The method of claim 15, wherein TiCl₄-containing carrier gas is returned to the carbochlorination process after step (iii).
